(19) United States
(12) Patent Application Publication
(10) Pub. No.: US 2013/0282326 A1
(43) Pub. Date: Oct. 24, 2013

(54) INERTIAL SENSOR CONTROL MODULE AND METHOD

(71) Applicants: Kyung Rin Kim, Gyunggi-do (KR); Byoung Won Hwang, Gyunggi-do (KR); Chang Hyun Kim, Gyunggi-do (KR)

(72) Inventors: Kyung Rin Kim, Gyunggi-do (KR); Byoung Won Hwang, Gyunggi-do (KR); Chang Hyun Kim, Gyunggi-do (KR)

(73) Assignee: SAMSUNG ELECTRO-MECHANICS CO., LTD., Gyunggi-do (KR)

(21) Appl. No.: 13/546,238

(22) Filed: Jul. 11, 2012

(30) Foreign Application Priority Data
Apr. 20, 2012 (KR) 1020120041618

(51) Int. Cl. G06F 15/00; G01P 15/00

(52) U.S. Cl. 702/142; 73/488

(57) ABSTRACT

Disclosed herein is an inertial sensor control module including: at least one inertial sensor including a driving mass and at least two pads connected to the driving mass; a driving unit applying a received control signal to the inertial sensor to drive the driving mass; a controlling unit connected to the driving unit and generating the control signal to transfer the control signal to the driving unit; and a sensing unit connected between the inertial sensor and the controlling unit and detecting information on whether the driving mass is in an abnormal resonance state for the control signal to transfer the detected information to the controlling unit.

### CROSS REFERENCE TO RELATED APPLICATION

This application claims the benefit of Korean Patent Application No. 10-2012-0041618, filed on Apr. 20, 2012, entitled “Inertial Sensor Control Module and Method”, which is hereby incorporated by reference in its entirety into this application.

### BACKGROUND OF THE INVENTION

1. Technical Field

The present invention relates to an inertial sensor control module and method.

2. Description of the Related Art

Recently, an inertial sensor has been used in various applications, for example, a military application such as an artificial satellite, a missile, an unmanned aircraft, or the like, an air bag, electronic stability control (ESC), a black box for a vehicle, hand shaking prevention of a camcorder, motion sensing of a mobile phone or a game machine, navigation, and the like.

The inertial sensor is divided into an acceleration sensor capable of measuring linear movement and an angular velocity sensor capable of measuring rotational movement.

Acceleration may be calculated by an equation regarding Newton's law of motion: “F=ma”, where “m” is a mass of a moving object, and “a” is acceleration to be measured. Angular velocity may be calculated by an equation regarding Coriolis force: “F=2mΩ×v”, where “m” represents the mass of the moving object, “Ω” represents the angular velocity to be measured, and “v” represents the motion velocity of the mass. In addition, a direction of the Coriolis force is determined by a velocity (v) axis and a rotational axis of angular velocity (Ω).

This inertial sensor may be divided into a ceramic sensor and a microelectromechanical systems (MEMS) sensor according to a manufacturing process thereof. Here, the MEMS sensor divided into a capacitive type sensor, a piezoresistive type sensor, a piezoelectric type sensor, and the like, according to the sensing principle.

Particularly, as it becomes easy to manufacture a small-sized and light MEMS sensor using a MEMS technology as described in Korean Patent Laid-Open Publication No. 2011-0072229 (published on Jun. 29, 2011), a function of an inertial sensor has also been continuously developed.

For example, the function and performance of the inertial sensor have been improved from a uniaxial sensor capable of detecting only inertial force for a single axis using a single sensor to a to multi-axis sensor capable of detecting inertia force for a multi-axis of two axes or more using a single sensor.

As described above, in order to implement a six-axis sensor detecting the multi-axis inertial forces, that is, three-axis acceleration and three-axis angular velocity using the single sensor, accurate and effective driving and control are required.

In the case of the inertial sensor according to the prior art, since a time in which a driving mass is stably driven may not be accurately recognized, a driving time and a sensing time should be set in consideration of a value of an error range or more.

Particularly, when a mass structure of the inertial sensor is not formed in a horizontal symmetrical or vertical symmetrical shape, even though the same force is applied to a pad provided in the mass, mass resonance cannot but be distorted by unbalance of the structure.

In addition, even though a process of manufacturing a MEMS is excellently and precisely performed, it is slightly difficult to precisely manufacture the mass structure so as to have an ideal value. Therefore, most of the masses of the inertial sensors are generally distorted by a manufacturing error of the MEMS structure to thereby abnormally vibrate, rather than being constantly operated by applied force, even though the same force is applied to each resonance pad.

Therefore, a method of individually controlling each pad may be applied; however, in this method, control circuits having the number corresponding to that of pads should be added.

For example, in the case in which there are four or more or eight or more pads for driving a mass in one inertial sensor, it is difficult to individually control each pad. As a result, an increase in a cost required for manufacturing an inertial sensor may be caused.

### SUMMARY OF THE INVENTION

The present invention has been made in an effort to provide an inertial sensor control module capable of actively controlling correction for each of the driving masses including at least two pads.

Further, the present invention has been made in an effort to provide an inertial sensor control method capable of actively controlling correction for each of the driving masses including at least two pads.

According to a preferred embodiment of the present invention, there is provided an inertial sensor control module including: at least one inertial sensor including a driving mass and at least two pads connected to the driving mass; a driving unit applying a received control signal to the inertial sensor to drive the driving mass; a controlling unit connected to the driving unit and generating the control signal to transfer the control signal to the driving unit; and a sensing unit connected between the inertial sensor and the controlling unit and detecting information on whether the driving mass is in an abnormal resonance state for the control signal to transfer the detected information to the controlling unit.

The driving mass may be an asymmetrical structure, and the inertial sensor may include an acceleration sensor capable of detecting three axial accelerations or an angular velocity sensor capable of detecting three axial angular velocities.

The controlling unit may include an automatic gain control (AGC), and the control signal may include a signal for applying a gain for correcting abnormal resonance of the driving mass to the driving mass using the AGC.

The controlling unit may compare a variance value regarding amplitude peak values of each of the pads with a threshold value to calculate the gain.

The threshold value may be set to 10% of the square of an average value of the amplitude peak values of each of the pads.

The sensing unit may receive a sensing request signal of the controlling unit and detect the amplitude peak values of each of the pads in the abnormal resonance state of the driving mass to transfer the detected amplitude peak values to the controlling unit.

According to another preferred embodiment of the present invention, there is provided an inertial sensor control method including: detecting, in a controlling unit, amplitude peak values of each of the pads connected to driving masses of the inertial sensor through a sensing unit, with respect to each of the driving masses that is in an abnormal resonance state; calculating, in the controlling unit, an average value (m) of the amplitude peak values and a variance value (V); comparing, in the controlling unit, the variance value (V) with a threshold value in order to select an AGC input representative value; selecting, in the controlling unit, a maximum peak value among the amplitude peak values or the average value (m) as the AGC input representative value according to a comparison result between the variance value (V) and the threshold value; performing AGC calculation for generating an AGC gain included in a control signal using the selected AGC input representative value; and applying, in the controlling unit, the control signal including the AGC gain to the driving masses through the driving unit to correct the abnormal resonance state of the driving masses.

In the comparing of the variance value (V) with the threshold value, the threshold value may be set to 10% of the square of the average value.

In the selecting of the maximum peak value or the average value (m) as the AGC input representative value, the controlling unit may select the average value (m) of the amplitude peak values as the AGC input representative value when the variance value (V) is smaller than or equal to the threshold value.

In the selecting of the maximum peak value or the average value (m) as the AGC input representative value, the controlling unit may select the maximum peak value among the amplitude peak values as the AGC input representative value when the variance value (V) is larger than the threshold value.

The driving mass may become the abnormal resonance state due to an asymmetrical structure, and the inertial sensor may include an acceleration sensor capable of detecting three axial accelerations or an angular velocity sensor capable of detecting three axial angular velocities.

The controlling unit may include an AGC and generate the control signal including the AGC gain.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram of an inertial sensor control module according to a preferred embodiment of the present invention;

FIG. 2 is a flow chart describing an inertial sensor control method according to another preferred embodiment of the present invention; and

FIGS. 3A and 3B are views describing the inertial sensor control method according to another preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

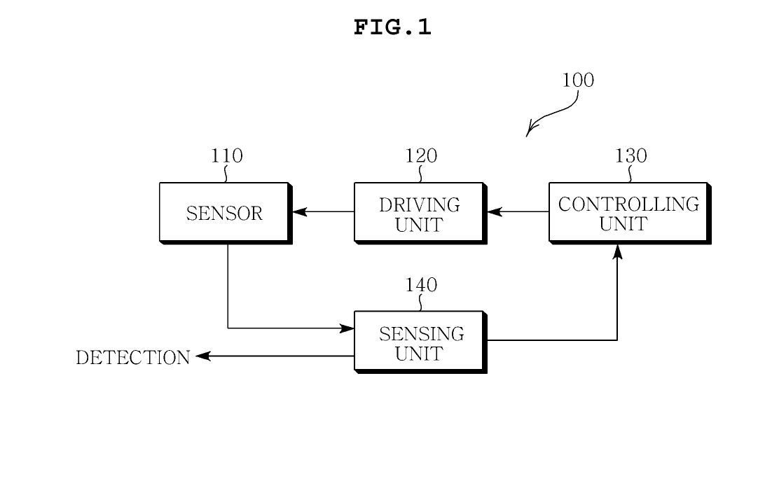

FIG. 1 is a block diagram of an inertial sensor control module according to a preferred embodiment of the present invention.

As shown in FIG. 1, the inertial sensor control module 100 according to the preferred embodiment of the present invention is configured to include an inertial sensor 110, a driving unit 120, a controlling unit 130, and a sensing unit 140.

The inertial sensor 110, which includes a driving mass and at least two pads connected to the driving mass, may include an acceleration sensor capable of detecting three axial accelerations positioned on a space or an angular velocity sensor capable of detecting three axial angular velocities. This inertial sensor 110 generates a signal corresponding to motion such as movement and rotation, wherein the generated signal is transferred to the controlling unit 130 through the sensing unit 140. Here, the case in which the inertial sensor 110 has a structure in which a mass structure is asymmetrically formed horizontally and vertically and horizontally according to a process of manufacturing a MEMS will be described by way of example.

The driving unit 120 is connected between the inertial sensor 110 and the controlling unit 130 and applies a control signal in order to drive the inertial sensor 110 according to a control of the controlling unit 130 or correct abnormal resonance of at least two pads provided in the mass.

The controlling unit 130 includes an automatic gain control (AGC) and applies a driving signal and a sensing signal to the driving unit 120 and the sensing unit 140, respectively, according to time series. Here, the controlling unit 130 may detect an abnormal resonance state of the inertial sensor 110 to apply an AGC gain to the inertial sensor 110 through the driving unit 120 in order to correct vibration of the pad.

Particularly, the controlling unit 130 determines whether each of at least two pads each provided in the driving mass of the inertial sensor 110 abnormally resonates. When each of at least two pads abnormally resonates, the controlling unit 130 may actively calculate a gain for correcting to the abnormal resonance for a plurality of pads to apply the gain to the inertial sensor 110.

In this case, the controlling unit 130 detects peak values and variance values of each pad and compares the detected variance values with a threshold value to select an average value or a maximum vibration peak value of the detected vibration peak values as an AGC input representative value, in order to actively calculate the gain for correcting the abnormal resonance for the plurality of pads. The controlling unit 130 may generate the gain for correcting the abnormal resonance for the plurality of pads by the ACG input representative value selected as described above to apply the gain to the inertial sensor 110.

The sensing unit 140 receives a sensing request signal from the controlling unit 130 and detects information on whether or not the driving masses of the inertial sensor 110 abnormally resonate and the vibration peak values of each of the pads connected to each driving mass to transfer the detected information and vibration peak values to the controlling unit 130.

The inertial sensor control module 100 according to the preferred embodiment of the present invention configured as described above actively detects whether or not the driving mass of the inertial sensor 110 abnormally resonates to apply the gain to the inertial sensor 110 using the AGC in order to correct a currently abnormal resonance state so as to become a set target value state.

Therefore, in the inertial sensor control module 100 according to the preferred embodiment of the present invention is asymmetrically provided horizontally and vertically and horizontally to correct the driving mass of the inertial sensor 110 that abnormally resonates so as to become the set target value state, thereby making it possible to reduce performance deterioration of the inertial sensor 110 and load of the inertial sensor 110.

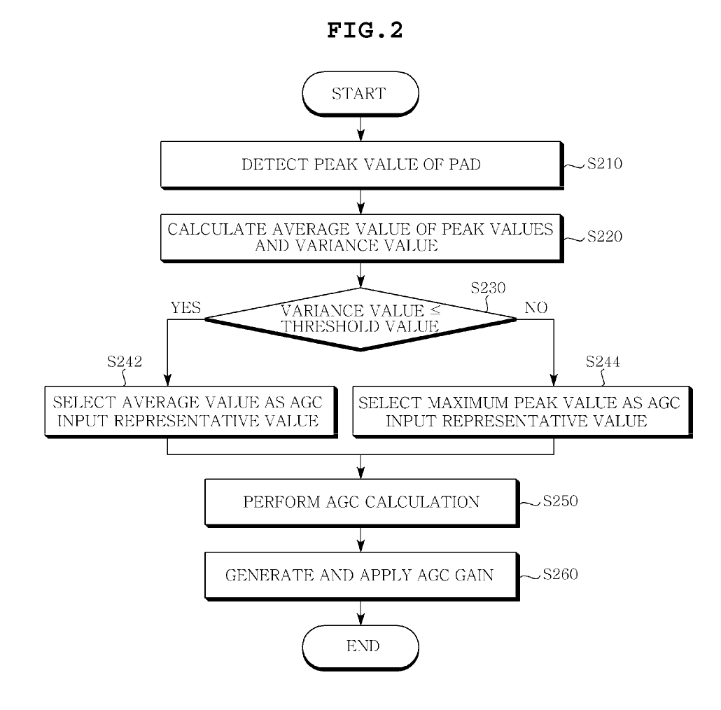

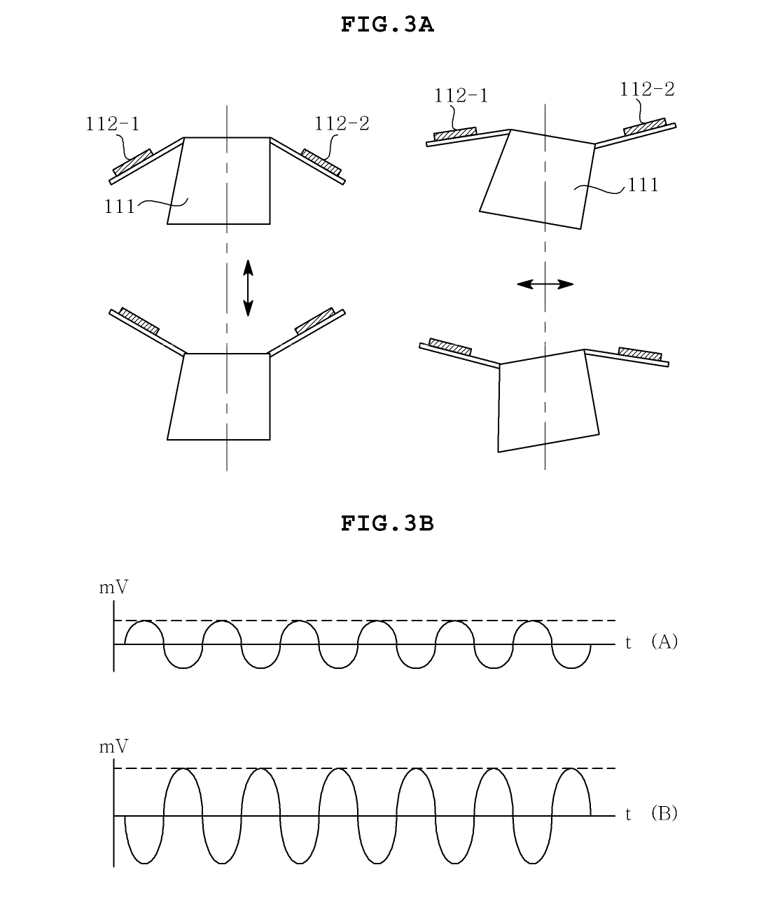

Hereinafter, an inertial sensor control method according to another preferred embodiment of the present invention will be described with reference to FIGS. 2 to 4. FIG. 2 is a flow chart describing an inertial sensor control method according to another preferred embodiment of the present invention; and FIGS. 3A and 3B are views describing the inertial sensor control method according to another preferred embodiment of the present invention.

In the inertial sensor control method according to another preferred embodiment of the present invention, first, the controlling unit 130 recognizes an abnormal resonance state of the driving mass driven in the inertial sensor 110 and detects amplitude peak values of at least two pads connected to the driving mass through the sensing part 140 (S210).

For example, the driving mass 111 of the inertial sensor 110 is asymmetrically provided vertically and horizontally as shown in FIG. 3A, such that two pads 112-1 and 112-2 provided in the driving mass 111 differently vibrate as shown in FIG. 3B.

That is, as shown in a vibration graph (A) of a left pad 112-1 and a vibration graph (B) of a right pad 112-2 of FIG. 3B, the driving mass 111 abnormally resonates, such that a difference in amplitude peak value is generated between voltage graphs detected in the left pad 112-1 and the right pad 112-2.

Therefore, when the difference in amplitude peak value is generated as described above, the controlling unit 130 may confirm that the driving mass 111 is in an abnormal resonance state.

At this time, the controlling unit 130 detects the amplitude peak values of each of the pads including the left pad 112-1 and the right pad 112-2 through the sensing unit 140.

After the controlling unit 130 detects the amplitude peak values of each pad, it calculates each of an average value (m) of the amplitude peak values and a variance value (V) (S220).

For example, the controlling unit 130 may detect the amplitude peak values for the pads provided in all of the driving masses as represented by Equation 1 in order to calculate the average value (m) of the amplitude peak values.

$$m = \frac{a + b + c + …}{n} \qquad [ Equation 1 ]$$

(Where a indicates an amplitude peak value of the left pad 112-1, b indicates an amplitude peak value of the right pad 112-2, c indicates an amplitude peak value of another pad, and n indicates the number of pads)

In order to calculate a variance value (V) for the average value (m) calculated as described above, Equation 2 may be used.

$$V = [ \frac{{a}^{2} + {b}^{2} + {c}^{2} + …}{n} ] - {m}^{2} \qquad [ Equation 2 ]$$

With respect to the variance value (V) calculated as described above, the controlling unit 130 compares the variance value (V) with a threshold value in order to select an AGC input representative value (S230).

Specifically, the threshold value to be compared with the variance value (V) may be defined as 10% of the square (m²) of the average value, and the controlling unit 130 compares the variance value (V) and the threshold value with each other to determine whether the variance value (V) is smaller than or equal to the threshold value.

$$V \leq {m}^{2} \times \frac{1}{10} \qquad [ Equation 3 ]$$

When it is determined that the variance value (V) is smaller than or equal to the threshold value, the controlling unit 130 selects the average value (m) of the amplitude peak values as the AGC input representative value (S242).

Here, as the average value (m) of the amplitude peak value is selected as the AGC input representative value, the controlling unit 130 applies the AGC gain to the inertial sensor 110 through the driving unit 120, thereby making it possible to reduce an error rate of the corrected vibration peak value of the pad with respect to the target resonance value.

On the other hand, when it is determined in comparing step (S230) that the variance value (V) is larger than the threshold value, the controlling unit 130 selects a maximum peak value among the amplitude peak values as the AGC input representative value (S244).

The reason why the maximum peak value is selected as the AGC input representative value is that when an intermediate value or a minimum value among the amplitude peak values is selected as the AGC input representative value to generate a gain, vibration larger than a target value may be generated in a pad having a peak value larger than the representative value. As a result, an excess gain is applied to the mass, such that damage may be generated in the mass, or vibration larger than the target value is generated in the pad, such that various problems may be generated.

Therefore, in the case in which the variance value is larger than the threshold value, the maximum peak value is selected as the AGC input representative value, thereby making it possible to generate the AGC gain so that the pads may maximally stably resonate in a state in which a deviation of vibration peak values of the pads is large even through other peak values do not arrive at the target value.

Then, the controlling unit 130 performs AGC calculation in order to generate the AGC gain using the AGC input representative value of the average value (m) or the maximum peak value selected as described above (S250).

After the controlling unit 130 performs the AGC calculation, it applies the AGC gain to the inertial sensor 110 to correct an abnormal resonance state of the driving mass 111 (S260).

Therefore, with the inertial sensor control method according to another preferred embodiment of the present invention, even though the mass 111 having an asymmetrical structure becomes an abnormal resonance state due to a structural defect, an AGC gain appropriate for the state is applied using the variance value, thereby making it possible to correct the abnormal resonance state so that the inertial sensor 110 may maximally stably resonate.

Hereinafter, a process of applying an AGC gain appropriate for a state using a variance value to correct an abnormal resonance state in the inertial sensor control method according to another preferred embodiment of the present invention will be described through Example 1 and Example 2.

### Example 1

In Example 1, the case in which a target resonance value of 30 mV is set with respect to the inertial sensor 110 having an amplitude peak value detected to be 12 mV in the vibration graph (A) of the left pad 112-1 of FIG. 3B and an amplitude peak value detected to be 14 mV in the vibration graph (B) of the right pad 112-2 of FIG. 3B will be described by way of example.

The controlling unit 130 detects that an average value (m) of the amplitude peak values is 13 mV and a variance value (V) is 1 mV.

Then, the controlling unit 130 calculates a threshold value of 16.9 mV according to the definition of the threshold value described above, that is, 10% of the square (m²) of the average value and compares the variance value (V) of 1 mV with the threshold value of 16.9 mV.

Since the variance value (V) is smaller than the threshold value as a result of comparing the variance value (V) of 1 mV with the threshold value of 16.9 mV, the controlling unit 130 selects the average value (m) of 13 mV as the AGC input representative value.

The controlling unit 130 compares the average value (m) of 13 mV selected as the AGC input representative value with the target resonance value of 30 mV to generate an AGC gain of 2.3 and applies the AGC gain of 2.3 to the inertial sensor 110.

Therefore, an amplitude of the left pad 112-1 is corrected to be 28 mV, and an amplitude of the right pad 112-2 is corrected to be 32 mV.

When these results are compared with the target resonance value of 30 mV, the left pad 112-1 has an error rate of 6.7% with respect to the target resonance value, and the right pad 112-2 also has an error rate of 6.7% with respect to the target resonance value.

When the amplitude peak value (14 mV) of the right pad 112-2, which is the maximum peak value, rather than the average value (m) is selected as the AGC input representative value in Example 1, an AGC gain of 2.1 is generated to thereby be applied to the inertial sensor 110.

Therefore, an amplitude of the left pad 112-1 is 25 mV, and an amplitude of the right pad 112-2 is 29 mV. When these results are compared with the target resonance value of 30 mV, the left pad 112-1 has an error rate of 16.7% with respect to the target resonance value, and the right pad 112-2 has an error rate of 3.3% with respect to the target resonance value, as shown in the following Table 1.

TABLE 1

| | Peak | Select | Select Maximum |
|---|---|---|---|
| | Value | Average Value | Peak Value |
| A | 12 | 28 (6.7%) | 25 (16.7%) |
| B | 14 | 32 (6.7%) | 29 (3.3%) |

Therefore, in Example, 1 the average value (m) needs to be selected as the AGC input representative value in order to maximally reduce the error rate with respect to the target resonance value.

### Example 2

In Example 2, the case in which a target resonance value of 30 mV is set with respect to the inertial sensor 110 having an amplitude peak value detected to be 4 mV in the vibration graph (A) of the left pad 112-1 of FIG. 3B and an amplitude peak value detected to be 14 mV in the vibration graph (B) of the right pad 112-2 of FIG. 3B will be described by way of example.

The controlling unit 130 detects that an average value (m) of the amplitude peak values is 9 mV and a variance value (V) is 25 mV.

Then, the controlling unit 130 calculates a threshold value of 8 mV according to the definition of the threshold value described above and compares the variance value (V) of 25 mV with the threshold value of 8 mV.

Since the variance value (V) is larger than the threshold value as a result of comparing the variance value (V) of 25 mV with the threshold value of 8 mV, the controlling unit 130 selects the maximum peak value of 14 mV as the AGC input representative value.

The controlling unit 130 compares the maximum peak value of 14 mV selected as the AGC input representative value with the target resonance value of 30 mV to generate an AGC gain of 2.1 and applies the AGC gain of 2.1 to the inertial sensor 110.

Therefore, an amplitude of the left pad 112-1 is corrected to be 8 mV, and an amplitude of the right pad 112-2 is corrected to be 29 mV.

When these results are compared with the target resonance value of 30 mV, the left pad 112-1 has an error rate of 73.3% with respect to the target resonance value, and the right pad 112-2 also has an error rate of 3.3% with respect to the target resonance value.

When the average value (m) of 9 mV rather than the maximum peak value is selected as the AGC input representative value in Example 2, an AGC gain of 3.3 is generated to thereby be applied to the inertial sensor 110.

Therefore, an amplitude of the left pad 112-1 is 13 mV, and an amplitude of the right pad 112-2 is 46 mV. When these results are compared with the target resonance value of 30 mV, the left pad 112-1 has an error rate of 56.7% with respect to the target resonance value, and the right pad 112-2 has an error rate of 53.3% with respect to the target resonance value, as shown in the following Table 2.

TABLE 2

| | Peak | Select | Select Maximum |
|---|---|---|---|
| | Value | Average Value | Peak Value |
| A | 4 | 13 (56.7%) | 8 (73.3%) |
| B | 14 | 46 (53.3%) | 29 (3.3%) |

Here, overflow that the right pad 112-2 significantly vibrates out of the target resonance value of 30 mV is generated, such that the mass may be damaged.

Therefore, in Example 2, the maximum peak value is selected as the AGC input representative value to generate and apply the AGC gain, thereby making it possible to accomplish maximally stable resonance in a state in which a deviation of vibration peak values of the pads is large even through other pads do not arrive at the target resonance value.

As set forth above, with the inertial sensor control module according to the preferred embodiment of the present invention, the driving mass of the inertial sensor provided in an asymmetrical form to abnormally resonate is corrected so to become a set target resonance value state, thereby making it possible to reduce performance deterioration of the inertial sensor and load of the inertial sensor.

In addition, with the inertial sensor control method according to the preferred embodiment of the present invention, even though the driving mass having an asymmetrical structure becomes an abnormal resonance state due to a structural defect, an AGC gain appropriate for the state is calculated and applied using the variance value, thereby making it possible to correct the abnormal resonance state so that the inertial sensor may maximally stably resonate.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. An inertial sensor control module comprising:
at least one inertial sensor including a driving mass and at least two pads connected to the driving mass;
a driving unit applying a received control signal to the inertial sensor to drive the driving mass;
a controlling unit connected to the driving unit and generating the control signal to transfer the control signal to the driving unit; and
a sensing unit connected between the inertial sensor and the controlling unit and detecting information on whether the driving mass is in an abnormal resonance state for the control signal to transfer the detected information to the controlling unit.

2. The inertial sensor control module as set forth in claim 1, wherein the driving mass is an asymmetrical structure, and
the inertial sensor includes an acceleration sensor capable of detecting three axial accelerations or an angular velocity sensor capable of detecting three axial angular velocities.

3. The inertial sensor control module as set forth in claim 1, wherein the controlling unit includes an automatic gain control (AGC), and
the control signal includes a signal for applying a gain for correcting abnormal resonance of the driving mass to the driving mass using the AGC.

4. The inertial sensor control module as set forth in claim 3, wherein the controlling unit compares a variance value regarding amplitude peak values of each of the pads with a threshold value to calculate the gain.

5. The inertial sensor control module as set forth in claim 4, wherein the threshold value is set to 10% of the square of an average value of the amplitude peak values of each of the pads.

6. The inertial sensor control module as set forth in claim 1, wherein the sensing unit receives a sensing request signal of the controlling unit and detects the amplitude peak values of each of the pads in the abnormal resonance state of the driving mass to transfer the detected amplitude peak values to the controlling unit.

7. An inertial sensor control method comprising:
detecting, in a controlling unit, amplitude peak values of each of the pads connected to driving masses of the inertial sensor through a sensing unit, with respect to each of the driving masses that is in an abnormal resonance state;
calculating, in the controlling unit, an average value (m) of the amplitude peak values and a variance value (V);
comparing, in the controlling unit, the variance value (V) with a threshold value in order to select an AGC input representative value;
selecting, in the controlling unit, a maximum peak value among the amplitude peak values or the average value (m) as the AGC input representative value according to a comparison result between the variance value (V) and the threshold value;
performing AGC calculation for generating an AGC gain included in a control signal using the selected AGC input representative value; and
applying, in the controlling unit, the control signal including the AGC gain to the driving masses through the driving unit to correct the abnormal resonance state of the driving masses.

8. The inertial sensor control method as set forth in claim 7, wherein in the comparing of the variance value (V) with the threshold value, the threshold value is set to 10% of the square of the average value.

9. The inertial sensor control method as set forth in claim 7, wherein in the selecting of the maximum peak value or the average value (m) as the AGC input representative value, the controlling unit selects the average value (m) of the amplitude peak values as the AGC input representative value when the variance value (V) is smaller than or equal to the threshold value.

10. The inertial sensor control method as set forth in claim 7, wherein in the selecting of the maximum peak value or the average value (m) as the AGC input representative value, the controlling unit selects the maximum peak value among the amplitude peak values as the AGC input representative value when the variance value (V) is larger than the threshold value.

11. The inertial sensor control method as set forth in claim 7, wherein the driving mass becomes the abnormal resonance state due to an asymmetrical structure, and
the inertial sensor includes an acceleration sensor capable of detecting three axial accelerations or an angular velocity sensor capable of detecting three axial angular velocities.

12. The inertial sensor control method as set forth in claim 7, wherein the controlling unit includes an AGC and generates the control signal including the AGC gain.
